(19) United States
(12) Patent Application Publication
(10) Pub. No.: US 2025/0368852 A1
(43) Pub. Date: Dec. 4, 2025

(54) MULTILAYER COMPOSITE

(71) Applicant: SAINT-GOBAIN PERFORMANCE PLASTICS CORPORATION, Malvern, PA (US)

(72) Inventors: Jing ZHOU, Shanghai (CN); Yue DONG, Shanghai (CN); Song YU, Shanghai (CN)

(21) Appl. No.: 19/221,813

(22) Filed: May 29, 2025

Related U.S. Application Data
(60) Provisional application No. 63/664,803, filed on Jun. 27, 2024.

(30) Foreign Application Priority Data
May 31, 2024 (CN) 202410702645.3

(51) Int. Cl. C09D 175/08; B60R 13/06; C09K 3/10

(52) U.S. Cl. CPC C09D 175/08; B60R 13/06; C09K 3/1021; C09K 2003/1084; C09K 2200/065

(57) ABSTRACT

The present disclosure relates to a multilayer composite that may include a foam layer, and a multilayer topcoat component overlying the foam layer. The multilayer topcoat component may include a first topcoat layer that includes a polyether polyurethane material, and a second topcoat layer that includes a hydrophobic polyurethane material. The second topcoat layer may overly the first topcoat layer, and the multilayer composite material may have a water resistance rating of at least about 10 hours.

### CROSS-REFERENCE TO RELATED APPLICATIONS

This application claims priority to Chinese Patent Application No. 202410702645.3, entitled “MULTILAYER COMPOSITE,” by Jing ZHOU et al., filed May 31, 2024, which is assigned to the current assignee hereof and is incorporated herein by reference in its entirety. This Application further claims priority under 35 U.S.C. § 119 (e) to U.S. Provisional Patent Application No. 63/664,803, entitled “MULTILAYER COMPOSITE,” by Jing ZHOU et al., filed Jun. 27, 2024, which is assigned to the current assignee hereof and is incorporated herein by reference in its entirety.

### FIELD OF THE DISCLOSURE

The present disclosure relates to a multilayer composite and, in particular, a multilayer composite with improved water sealing properties and low surface tackiness. More particularly, the present disclosure related to a multilayer composite for use as a sealing material in various automotive application applications.

### BACKGROUND

Multilayer composite films may be designed for use as a sealing material or seal component in various applications, for example, for use in various automotive applications where the seal is placed under compression between two components. However, in these, and in other applications, the material must balance providing excellent sealing performance under compression without adhering permanently to a components surface that is applying the compression. Accordingly, there is a continuing need for improved multilayer composite materials that include improved water sealing properties and low surface tackiness to avoid undesired adhesion.

### SUMMARY

According to a first aspect, a multilayer composite may include a foam layer, and a multilayer topcoat component overlying the foam layer. The multilayer topcoat component may include a first topcoat layer that includes a polyether polyurethane material, and a second topcoat layer that includes a hydrophobic polyurethane material. The second topcoat layer may overly the first topcoat layer, and the multilayer composite material may have a water resistance rating of at least about 10 hours.

### BRIEF DESCRIPTION OF THE DRAWINGS

Embodiments are illustrated by way of example and are not limited to the accompanying figures.

FIG. 1 includes an illustration of an example multilayer composite according to certain embodiments described herein;

FIG. 2a includes an image of a U-Test set up for determining the water resistance rating of a material;

FIG. 2b includes an image of a U-Test set up for determining the water resistance rating of a material;

FIG. 2c includes an image of a U-Test set up for determining the water resistance rating of a material;

FIG. 3a includes an image of a friction force tackiness test set-up for determining the tackiness of a material;

FIG. 3b includes an image of a friction force tackiness test set-up for determining the tackiness of a material; and

FIG. 3c includes an image of a friction force tackiness test set-up for determining the tackiness of a material.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer composite that may include a foam layer, and a multilayer topcoat component overlying the foam layer. According to particular embodiments, the multilayer topcoat component may include a first topcoat layer that may include a polyether polyurethane material, and a second topcoat layer that may include a hydrophobic polyurethane material.

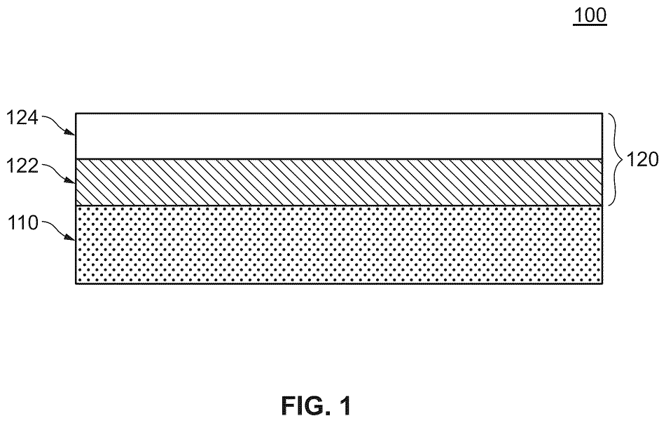

For purposes of illustration, FIG. 1 shows a multilayer composite 100 according to embodiments described herein. As shown in FIG. 1, a multilayer composite 100 may include a core foam layer 110, and a multilayer topcoat component 120. According to particular embodiments, the multilayer topcoat component 120 may include a first topcoat layer 122 and a second topcoat layer 124.

According to certain embodiments, the first topcoat layer 122 may include a polyether polyurethane material.

According to certain embodiments, the first topcoat layer 122 may be formed from a first topcoat layer aqueous forming solution that may include a particular polyether polyurethane material solid content. For example, the first topcoat layer aqueous forming solution may include a polyether polyurethane material solid content of at least about 15 wt. % for a total weight of the first topcoat layer aqueous forming solution, such as, at least about 18 wt. % or at least about 20 wt. % or at least about 23 wt. % or at least about 25 wt. % or at least about 28 wt. % or even at least about 30 wt. %. According to still other embodiments, the first topcoat layer aqueous forming solution may include a polyether polyurethane material solid content of not greater than about 50 wt. % for a total weight of the first topcoat layer aqueous forming solution, such as not greater than about 48 wt. % or not greater than about 45 wt. % or not greater than about 43 wt. % or not greater than about 40 wt. % or not greater than about 38 wt. % or even not greater than about 35 wt. %. It will be appreciated that the first topcoat layer aqueous forming solution may include a polyether polyurethane material solid content of any value within a range between any of the minimum and maximum values noted above. It will be further appreciated that the first topcoat layer aqueous forming solution may include a polyether polyurethane material solid content of any value between any of the minimum and maximum values noted above.

According to still other embodiments, the first topcoat layer 122 may include a particular content of polyether polyurethane material. For example, the top first topcoat layer 122, may include a polyether polyurethane material content of at least about 90 wt. % for a total weight of the first topcoat layer 122, such as at least about 91 wt. % or at least about 92 wt. % or at least about 93 wt. % or at least about 94 wt. % or at least about 95 wt. % or at least about 96 wt. % or at least about 97 wt. % or at least about 98 wt. % or even at least about 99 wt. %. It will be appreciated that the first topcoat layer 122 may include a polyether polyurethane material content of any value within a range between any of the minimum and maximum values noted above. It will be further appreciated that the first topcoat layer 122 may include a polyether polyurethane material content of any value between any of the minimum and maximum values noted above.

According to yet other embodiments, the first topcoat layer 122 may consist essentially of a polyether polyurethane material. According to still other embodiments, the first topcoat layer 122 may be a polyether polyurethane material layer.

According to yet other embodiments, the first topcoat layer 122 aqueous forming solution may have a particular viscosity as measured according to ASTM D2196. For example, the first topcoat layer 122 aqueous forming solution may have a viscosity of at least about 200 mPa*s, such as at least about 210 mPa*s or at least about 220 mPa*s or at least about 230 mPa*s or at least about 240 mPa*s or at least about 250 mPa*s or at least about 260 mPa*s or at least about 270 mPa*s or at least about 280 mPa*s least about 290 mPa*s or at least about 300 mPa*s or at least about 310 mPa*s or at least about 320 mPa*s or at least about 330 mPa*s or at least about 340 mPa*s or even at least about 350 mPa*s. According to yet other embodiments, the first topcoat layer 122 aqueous forming solution may have a viscosity of not greater than about 1000 mPa*s, such as not greater than about 950 mPa*s or not greater than about 900 mPa*s or not greater than about 850 mPa*s or not greater than about 800 mPa*s or not greater than about 750 mPa*s or not greater than about 700 mPa*s or not greater than about 650 mPa*s or not greater than about 600 mPa*s or not greater than about 590 mPa*s or not greater than about 580 mPa*s or not greater than about 570 mPa*s or not greater than about 560 mPa*s or not greater than about 550 mPa*s or not greater than about 540 mPa*s or not greater than about 530 mPa*s or not greater than about 520 mPa*s or not greater than about 510 mPa*s or not greater than about 500 mPa*s or not greater than 490 mPa*s or not greater than about 480 mPa*s or not greater than about 470 mPa*s or not greater than about 460 mPa*s or even not greater than about 450 mPa*s. It will be appreciated that the first topcoat layer 122 aqueous forming solution may have a viscosity of any value within a range between any of the minimum and maximum values noted above. It will be further appreciated that the first topcoat layer 122 aqueous forming solution may have a viscosity of any value between any of the minimum and maximum values noted above.

According to yet other embodiments, the first topcoat layer 122 aqueous forming solution may have a particular pH value as measured according to ASTM D70. For example, the first topcoat layer 122 aqueous forming solution may have a pH value of at least about 7.0, such as at least about 7.2 or at least about 7.4 or at least about 7.6 or at least about 7.8 or at least about 8.0 or at least about 8.1 or at least about 8.2 or at least about 8.3 or even at least about 8.4. According to yet other embodiments, the first topcoat layer 122 aqueous forming solution may have a pH value of not greater than about 10.0, such as not greater than about 9.8 or not greater than about 9.6 or not greater than about 9.4 or not greater than about 9.2 or not greater than about 9.0 or not greater than about 8.9 or not greater than about 8.8 or not greater than about 8.7 or even not greater than about 8.6. It will be appreciated that the first topcoat layer 122 aqueous forming solution may have a pH value of any value within a range between any of the minimum and maximum values noted above. It will be further appreciated that the first topcoat layer 122 aqueous forming solution may have a pH value of any value between any of the minimum and maximum values noted above.

According to yet other embodiments, the first topcoat layer 122 aqueous forming solution may have a particular specific gravity as measured according to ASTM D2697. For example, the first topcoat layer 122 aqueous forming solution may have a specific gravity of at least about 950 kg/m³, such as at least about 960 kg/m³ or at least about 970 kg/m³ or at least about 980 kg/m³ or even at least about 990 kg/m³. According to yet other embodiments, the first topcoat layer 122 aqueous forming solution may have a specific gravity of not greater than about 1050 kg/m³, such as not greater than about 1040 kg/m³ or not greater than about 1030 kg/m³ or not greater than about 1020 kg/m³ or even not greater than about 1010 kg/m³. It will be appreciated that the first topcoat layer 122 aqueous forming solution may have a specific gravity of any value within a range between any of the minimum and maximum values noted above. It will be further appreciated that the first topcoat layer 122 aqueous forming solution may have a specific gravity of any value between any of the minimum and maximum values noted above.

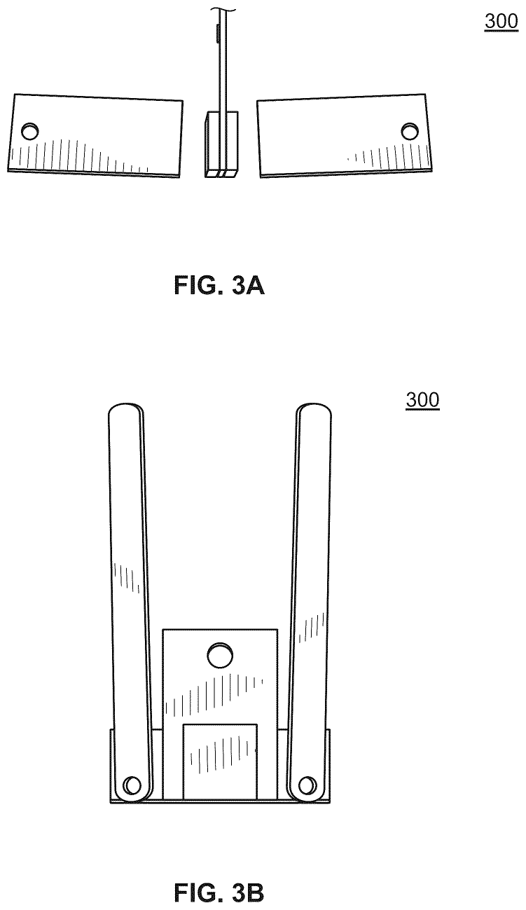

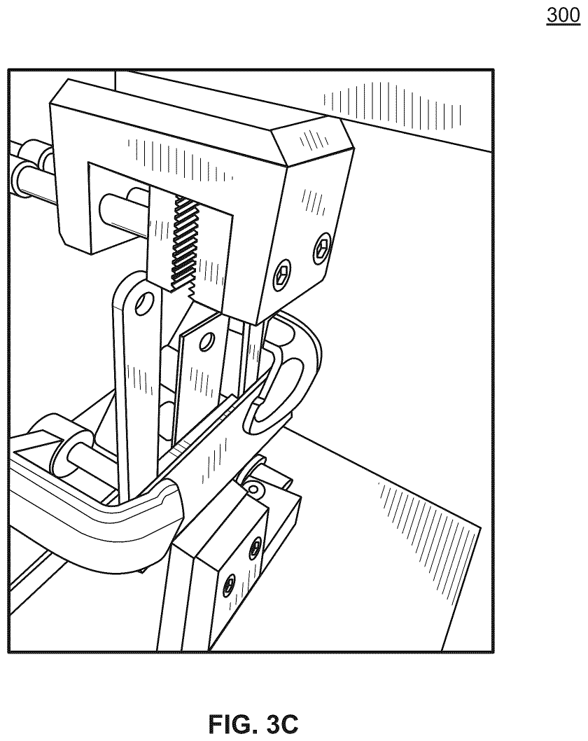

According to yet other embodiments, the first topcoat layer 122 may have a particular tackiness. For purposes of embodiments that are described hererin, the tackiness of a particular sample is measured according to a friction force tackiness test, where the friction force tackiness test is conducted using a test set-up 300 as shown in FIGS. 3a, 3b, and 3c, and by applying the following procedure: 1) prepareing the test sample by attaching two pieces of 1 inch by 1 inch cuboid shaped foam sample material (material to be tested for tackiness) on two sides of a flat stainless steel metal plate using an adhesive, the metal plate having a length of 75 mm, a width of 28 mm, and a thickness of 2 mm, a weight of 10.88 g, the foam being attached in the middle of the bottom part of the metal plate with the side of each piece of foam aligned with the bottom (corresponding to the width) of the metal plate (as shown in FIG. 3a); compressing the sample (i.e., the foam pieces that are attached to the metal plate) between two pieces of painting panels so that the foams are aligned with the central part of the painting panels (the two painting panels and the metal plate should be kept vertical and parallel to each other, and the two painting panels are placed horizontally along the length direction) (as shown in FIG. 3b); inserting a feeler gauge on the left and right sides, and using a clamp to fix the distance of two painting panels so that the two foam sample materials in between the two panels are compressed by 20%, 2) testing the friction force between foam and painting panel using a texture analyzer where a bottom clamp fixes the bottom side of painting panels, and an upper clamp fix the metal plate, then the upper clamp pulls the metal plate straight up (with attached foam) at the speed of 300 mm/min, until the foam is pulled out of painting panels (as shown in FIGS. 3c), and 3) during pulling procedure, the Texture Analyzer records the friction force between foam and painting panels (since there are two contact interfaces between foam and painting panels, one-side friction force is equal to the maximum friction force divided by two). For purposes of the test described herein, the two pieces of painting panels used in the test are standard test panels from ACT Test Panels LLC (CRS 04×12×0332 B958 P901E: U32AD800 P: U28WU743S B: R98WU321C White C: R10CG060Z). The tackiness is calculated by the equation as follows: the tackiness=(one side friction force)÷(surface area of the foam sample material). The surface area of the foam sample material is 1 inch². According to particular embodiments, the first topcoat layer 122 may have a tackiness of at least about 0.1 kPa, such as at least about 1.0 kPa or at least about 2.0 kPa or at least about 5.0 kPa or even at least about 7 kPa. According to yet other embodiments, the first topcoat layer 122 may have a tackiness of not greater than about 18.0 kPa, such as not greater than about 16.0 kPa or not greater than about 14.0 kPa or not greater than about 12.0 kPa or even not greater than about 10.0 kPa. It will be appreciated that the first topcoat layer 122 may have a tackiness of any value within a range between any of the minimum and maximum values noted above. It will be further appreciated that the first topcoat layer 122 may have a tackiness of any value between any of the minimum and maximum values noted above.

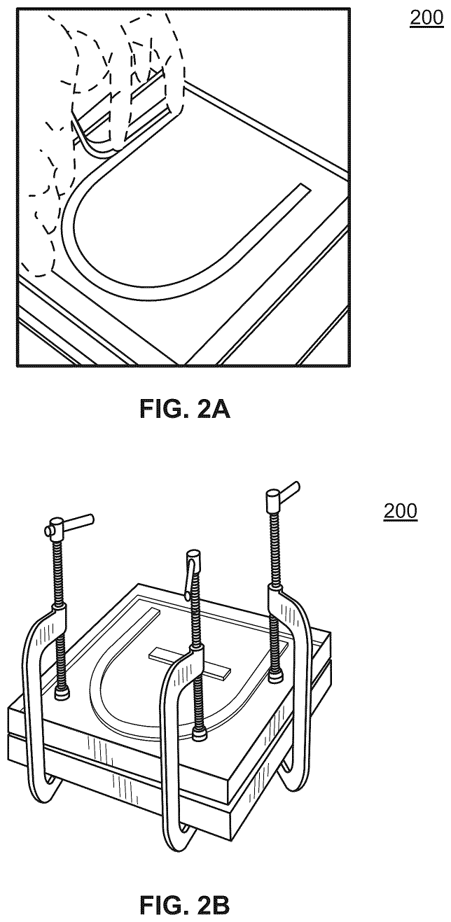

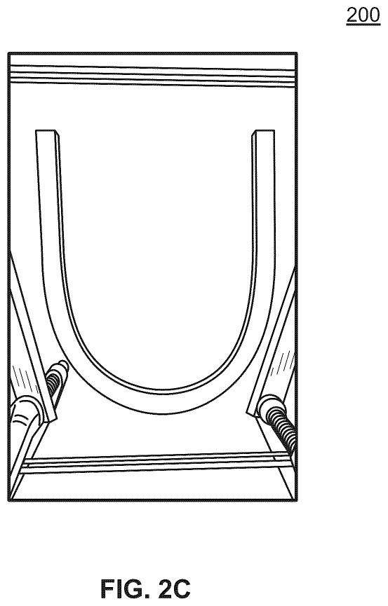

According to yet other embodiments, the first topcoat layer 122 may have a particular water resistance rating. For purposes of embodiments that are described herein, the water resistance rating is defined as the amount of time that a sample resists water leakage as measured according to a water resistance U-test, where the water resistance U-test is conducted using a test set-up 200 as shown in FIGS. 2a, 2b, and 2c, and by applying the following procedure: 1) cutting a sample of the material into a strip that is 10 mm wide and 400 mm long, 2) attaching the sample to a clean glass U-shape (a sample that has a semicircle at the bottom, and the diameter of the circle is 10 cm) (as shown in FIG. 2a), 3) compressing the sample between two glass plates to 70% of its original thickness and fixing the compression by feeler gauges and clamps (as shown in FIG. 2b), 4) standing the compressed set-up vertically, 5) adding water to a height of 10 cm within the compressed U-shaped sample after it has been compressing for 1 hour (as shown in FIGS. 2c), and 6) observing the length of time that passes before water is observed passing through the U-shaped sample (i.e., water leakage-defined as a water droplet with a diameter larger than 0.5 mm leaks out of the external rim of the U-shape). According to certain embodiments, the first topcoat layer 122 may have a water resistance of at least about 1 hour, at least about 3 hours, at least about 5 hours, at least about 7 hours, at least about 10 hours, such as at least about 15 hours or at least about 20 hours or at least about 25 hours or at least about 30 hours or at least about 35 hours or at least about 40 hours or at least about 45 hours or at least about 50 hours or at least about 55 hours or at least about 60 hours or at least about 70 hours or even at least about 72 hours. It will be appreciated that the first topcoat layer 122 may have a water resistance of any value within a range between any of the minimum and maximum values noted above. It will be further appreciated that the first topcoat layer 122 may have a water resistance of any value between any of the minimum and maximum values noted above.

According to still other embodiments, the first topcoat layer 122 may have a particular thickness. For example, the first topcoat layer 122 may have a thickness of at least about 2 microns, such as at least about 4 microns or at least about 6 microns or at least about 8 microns or even at least about 10 microns. According to yet other embodiments, the first topcoat layer 122 may have a thickness of not greater than about 20 microns such as not greater than about 18 microns or not greater than about 16 microns or not greater than about 14 microns or even not greater than about 12 microns. It will be appreciated that the first topcoat layer 122 may have a thickness of any value within a range between any of the minimum and maximum values noted above. It will be further appreciated that the first topcoat layer 122 may have a thickness of any value between any of the minimum and maximum values noted above.

According to certain embodiments, the second topcoat layer 124 may include a hydrophobic polyurethane material.

According to certain embodiments, the second topcoat layer 124 may be formed from a second topcoat layer aqueous forming solution that may include a particular hydrophobic polyurethane material solid content. For example, the second topcoat layer aqueous forming solution may include a hydrophobic polyurethane material solid content of at least about 15 wt. % for a total weight of the second topcoat layer aqueous forming solution, such as, at least about 18 wt. % or at least about 20 wt. % or at least about 23 wt. % or at least about 25 wt. % or at least about 28 wt. % or even at least about 30 wt. %. According to still other embodiments, the second topcoat layer aqueous forming solution may include a hydrophobic polyurethane material solid content of not greater than about 50 wt. % for a total weight of the second topcoat layer aqueous forming solution, such as not greater than about 48 wt. % or not greater than about 45 wt. % or not greater than about 43 wt. % or not greater than about 40 wt. % or not greater than about 38 wt. % or even not greater than about 35 wt. %. It will be appreciated that the second topcoat layer aqueous forming solution may include a hydrophobic polyurethane material solid content of any value within a range between any of the minimum and maximum values noted above. It will be further appreciated that the second topcoat layer aqueous forming solution may include a hydrophobic polyurethane material solid content of any value between any of the minimum and maximum values noted above.

According to still other embodiments, the second topcoat layer 124 may include a particular content of hydrophobic polyurethane material. For example, the top second topcoat layer 124, may include a hydrophobic polyurethane material content of at least about 90 wt. % for a total weight of the second topcoat layer 124, such as at least about 91 wt. % or at least about 92 wt. % or at least about 93 wt. % or at least about 94 wt. % or at least about 95 wt. % or at least about 96 wt. % or at least about 97 wt. % or at least about 98 wt. % or even at least about 99 wt. %. It will be appreciated that the second topcoat layer 124 may include a hydrophobic polyurethane material content of any value within a range between any of the minimum and maximum values noted above. It will be further appreciated that the second topcoat layer 124 may include a hydrophobic polyurethane material content of any value between any of the minimum and maximum values noted above.

According to yet other embodiments, the second topcoat layer 124 may consist essentially of a hydrophobic polyurethane material. According to still other embodiments, the second topcoat layer 124 may be a hydrophobic polyurethane material layer.

According to yet other embodiments, the second topcoat layer 124 aqueous forming solution may have a particular viscosity as measured according to ASTM D2196. For example, the second topcoat layer 124 aqueous forming solution may have a viscosity of at least about 20 mPa*s, such as at least about 21 mPa*s or at least about 22 mPa*s or at least about 23 mPa*s or at least about 24 mPa*s or at least about 25 mPa*s or at least about 26 mPa*s or at least about 27 mPa*s or at least about 28 mPa*s least about 29 mPa*s or at least about 30 mPa*s or at least about 31 mPa*s or at least about 32 mPa*s or at least about 33 mPa*s or at least about 34 mPa*s or even at least about 35 mPa*s. According to yet other embodiments, the second topcoat layer 124 aqueous forming solution may have a viscosity of not greater than about 400 mPa*s, such as not greater than about 380 mPa*s or not greater than about 360 mPa*s or not greater than about 340 mPa*s or not greater than about 320 mPa*s or not greater than about 300 mPa*s or not greater than about 280 mPa*s or not greater than about 260 mPa*s or not greater than about 240 mPa*s or not greater than about 220 mPa*s or not greater than about 200 mPa*s or not greater than about 180 mPa*s or not greater than about 160 mPa*s or not greater than about 140 mPa*s or not greater than about 120 mPa*s or not greater than about 100 mPa*s or not greater than about 95 mPa*s or not greater than about 90 mPa*s or not greater than about 85 mPa*s or not greater than about 80 mPa*s or not greater than about 75 mPa*s or not greater than about 70 mPa*s or not greater than about 65 mPa*s or even not greater than about 60 mPa*s. It will be appreciated that the second topcoat layer 124 aqueous forming solution may have a viscosity of any value within a range between any of the minimum and maximum values noted above. It will be further appreciated that the second topcoat layer 124 aqueous forming solution may have a viscosity of any value between any of the minimum and maximum values noted above.

According to yet other embodiments, the second topcoat layer 124 aqueous forming solution may have a particular pH value as measured according to ASTM D70. For example, the second topcoat layer 124 aqueous forming solution may have a pH value of at least about 3.0, such as at least about 3.2 or at least about 3.4 or at least about 3.6 or at least about 3.8 or at least about 4.0 or at least about 4.1 or at least about 4.2 or at least about 4.3 or even at least about 4.4. According to yet other embodiments, the second topcoat layer 124 aqueous forming solution may have a pH value of not greater than about 6.0, such as not greater than about 5.8 or not greater than about 5.6 or not greater than about 5.4 or not greater than about 5.2 or not greater than about 5.0 or not greater than about 4.9 or not greater than about 4.8 or not greater than about 4.7 or even not greater than about 4.6. It will be appreciated that the second topcoat layer 124 aqueous forming solution may have a pH value of any value within a range between any of the minimum and maximum values noted above. It will be further appreciated that the second topcoat layer 124 aqueous forming solution may have a pH value of any value between any of the minimum and maximum values noted above.

According to yet other embodiments, the second topcoat layer 124 aqueous forming solution may have a particular specific gravity as measured according to ASTM D2697. For example, the second topcoat layer 124 aqueous forming solution may have a specific gravity of at least about 950 kg/m³, such as at least about 960 kg/m³ or at least about 970 kg/m³ or at least about 980 kg/m³ or even at least about 990 kg/m³. According to yet other embodiments, the second topcoat layer 124 aqueous forming solution may have a specific gravity of not greater than about 1050 kg/m³, such as not greater than about 1040 kg/m³ or not greater than about 1030 kg/m³ or not greater than about 1020 kg/m³ or even not greater than about 1010 kg/m³. It will be appreciated that the second topcoat layer 124 aqueous forming solution may have a specific gravity of any value within a range between any of the minimum and maximum values noted above. It will be further appreciated that the second topcoat layer 124 aqueous forming solution may have a specific gravity of any value between any of the minimum and maximum values noted above.

According to yet other embodiments, the second topcoat layer 124 may have a particular tackiness as measured according to the friction force tackiness test described hererin. For example, the second topcoat layer 124 may have a tackiness of at least about 23 kPa, such as at least about 25 kPa or at least about 30 kPa or at least about 35 kPa or even at least about 40 kPa. According to yet other embodiments, the second topcoat layer 124 may have a tackiness of not greater than about 100 kPa, such as not greater than about 80 kPa or not greater than about 60 kPa or not greater than about 50 kPa or even not greater than about 40 kPa. It will be appreciated that the second topcoat layer 124 may have a tackiness of any value within a range between any of the minimum and maximum values noted above. It will be further appreciated that the second topcoat layer 124 may have a tackiness of any value between any of the minimum and maximum values noted above.

According to yet other embodiments, the second topcoat layer 124 may have a particular water resistance rating. For purposes of embodiments that are described herein, the water resistance rating is defined as the amount of time that a sample resists water leakage as measured according to a water resistance U-test as described herein. For example, the second topcoat layer 124 may have a water resistance of at least about 10 hours, such as at least about 15 hours or at least about 20 hours or at least about 25 hours or at least about 30 hours or at least about 35 hours or at least about 40 hours or at least about 45 hours or at least about 50 hours or at least about 55 hours or at least about 60 hours or at least about 70 hours or even at least about 72 hours. It will be appreciated that the second topcoat layer 124 may have a water resistance of any value within a range between any of the minimum and maximum values noted above. It will be further appreciated that the second topcoat layer 124 may have a water resistance of any value between any of the minimum and maximum values noted above.

According to still other embodiments, the second topcoat layer 124 may have a particular thickness. For example, the second topcoat layer 124 may have a thickness of at least about 2 microns, such as at least about 4 microns or at least about 6 microns or at least about 8 microns or even at least about 10 microns. According to yet other embodiments, the second topcoat layer 124 may have a thickness of not greater than about 20 microns such as not greater than about 18 microns or not greater than about 16 microns or not greater than about 14 microns or even not greater than about 12 microns. It will be appreciated that the second topcoat layer 124 may have a thickness of any value within a range between any of the minimum and maximum values noted above. It will be further appreciated that the second topcoat layer 124 may have a thickness of any value between any of the minimum and maximum values noted above.

According to yet other embodiments, the multilayer topcoat component 120 may have a particular tackiness as measured according to the friction force tackiness test described hererin. For example, the multilayer topcoat component 120 may have a tackiness of at least about 0.1 kPa, such as at least about 1.0 kPa or at least about 2.0 kPa or at least about 5.0 kPa or even at least about 7 kPa. According to yet other embodiments, the multilayer topcoat component 120 may have a tackiness of not greater than about 18.0 kPa, such as not greater than about 16.0 kPa or not greater than about 14.0 kPa or not greater than about 12.0 kPa or even not greater than about 10.0 kPa. It will be appreciated that the multilayer topcoat component 120 may have a tackiness of any value within a range between any of the minimum and maximum values noted above. It will be further appreciated that the multilayer topcoat component 120 may have a tackiness of any value between any of the minimum and maximum values noted above.

According to yet other embodiments, the multilayer topcoat component 120 may have a particular water resistance as measured according to the water resistance U-Test described herein. For example, the multilayer topcoat component 120 may have a water resistance of at least about 10 hours, such as at least about 15 hours or at least about 20 hours or at least about 25 hours or at least about 30 hours or at least about 35 hours or at least about 40 hours or at least about 45 hours or at least about 50 hours or at least about 55 hours or at least about 60 hours or at least about 70 hours or even at least about 72 hours. It will be appreciated that the multilayer topcoat component 120 may have a water resistance of any value within a range between any of the minimum and maximum values noted above. It will be further appreciated that the multilayer topcoat component 120 may have a water resistance of any value between any of the minimum and maximum values noted above.

According to still other embodiments, the multilayer topcoat component 120 may have a particular thickness. For example, the multilayer topcoat component 120 may have a thickness of at least about 5 microns, such as at least about 10 microns or at least about 15 microns or even at least about 20 microns. According to yet other embodiments, the multilayer topcoat component 120 may have a thickness of not greater than about 40 microns such as not greater than about 35 microns or not greater than about 30 microns or not greater than about 25 microns or even not greater than about 20 microns. It will be appreciated that the multilayer topcoat component 120 may have a thickness of any value within a range between any of the minimum and maximum values noted above. It will be further appreciated that the multilayer topcoat component 120 may have a thickness of any value between any of the minimum and maximum values noted above.

According to yet other embodiments, the multilayer composite 100 may have a particular tackiness as measured according to the friction force tackiness test described hererin. For example, the multilayer composite 100 may have a tackiness of at least about 0.1 kPa, such as at least about 1.0 kPa or at least about 2.0 kPa or at least about 5.0 kPa or even at least about 7 kPa. According to yet other embodiments, the multilayer composite 100 may have a tackiness of not greater than about 18.0 kPa, such as not greater than about 16.0 kPa or not greater than about 14.0 kPa or not greater than about 12.0 kPa or even not greater than about 10.0 kPa. It will be appreciated that the multilayer composite 100 may have a tackiness of any value within a range between any of the minimum and maximum values noted above. It will be further appreciated that the multilayer composite 100 may have a tackiness of any value between any of the minimum and maximum values noted above.

According to yet other embodiments, the multilayer composite 100 may have a particular water resistance rating. For purposes of embodiments that are described herein, the water resistance rating is defined as the amount of time that a sample resists water leakage as measured according to a water resistance U-test as described herein. For example, the multilayer composite 100 may have a water resistance of at least about 10 hours, such as at least about 15 hours or at least about 20 hours or at least about 25 hours or at least about 30 hours or at least about 35 hours or at least about 40 hours or at least about 45 hours or at least about 50 hours or at least about 55 hours or at least about 60 hours or at least about 70 hours or even at least about 72 hours. It will be appreciated that the multilayer composite 100 may have a water resistance of any value within a range between any of the minimum and maximum values noted above. It will be further appreciated that the multilayer composite 100 may have a water resistance of any value between any of the minimum and maximum values noted above.

According to still other embodiments, the multilayer composite 100 may have a particular thickness. For example, the multilayer composite 100 may have a thickness of at least about 1 mm, such as at least about 2 mm or at least about 4 mm or at least about 6 mm or even at least about 8 mm. According to yet other embodiments, the multilayer composite 100 may have a thickness of not greater than about 20 mm such as not greater than about 18 mm or not greater than about 16 mm or not greater than about 14 mm or even not greater than about 12 mm. It will be appreciated that the multilayer composite 100 may have a thickness of any value within a range between any of the minimum and maximum values noted above. It will be further appreciated that the multilayer composite 100 may have a thickness of any value between any of the minimum and maximum values noted above.

According to other embodiments, the foam layer 110 may include a polyurethane-based foam. According to other embodiments, the foam layer 110 may consist essentially of a polyurethane-based foam. According to other embodiments, the foam layer 110 may be a polyurethane-based foam layer.

According to still other embodiments, the foam layer 110 may have a particular thickness. For example, the foam layer 110 may have a thickness of at least about 1 mm, such as at least about 2 mm or at least about 4 mm or at least about 6 mm or even at least about 8 mm. According to yet other embodiments, the foam layer 110 may have a thickness of not greater than about 20 mm such as not greater than about 18 mm or not greater than about 16 mm or not greater than about 14 mm or even not greater than about 12 mm. It will be appreciated that the foam layer 110 may have a thickness of any value within a range between any of the minimum and maximum values noted above. It will be further appreciated that the foam layer 110 may have a thickness of any value between any of the minimum and maximum values noted above.

According to certain embodiments, the multilayer composite material described herein may be formed according to any acceptable forming process for a multilayer composite material. According to certain embodiments, the multilayer composite may be formed by providing a foam layer and coating additional topcoat layers directly onto a surface of the foam layer. According to particular embodiments, the topcoat layers may be formed by providing a topcoat layer aqueous forming solution, coating the topcoat layer aqueous forming solution onto the foam layer, and then curing (i.e., thermally curing) the topcoat layer aqueous forming solution to form the topcoat layer. According to still other embodiments, multiple topcoat layers may be formed by providing a first topcoat layer aqueous forming solution, coating the first topcoat layer aqueous forming solution onto the foam layer, curing (i.e., thermally curing) the first topcoat layer aqueous forming solution to form the topcoat layer, then providing a second topcoat layer aqueous forming solution, coating the second topcoat layer aqueous forming solution onto the first topcoat layer, and curing (i.e., thermally curing) the second topcoat layer aqueous forming solution to form the second topcoat layer. It will be appreciated that the above noted process may be used to form any desired number of topcoat layers on the foam layer.

According to other embodiments, the multilayer composite material may be formed using a lamination process where the porous foam and additional layers are laminated using a transfer adhesive such as, for example, a silicon adhesive, a rubber adhesive, an acrylic adhesive, a phenolic adhesive, a polyurethane-based adhesive, or any combination thereof. According to still other embodiments, the multilayer composite material may be formed using a lamination process with a porous foam and an additional layer, where the coating on the additional layer is an adhesive, such as, a silicon adhesive, a rubber adhesive, an acrylic adhesive, a phenolic adhesive, a polyurethane-based adhesive, or any combination thereof. According to still other embodiments, the multilayer composite material may be formed using a direct cast forming process, wherein the foam is directly cast onto the additional films or between the additional films.

Tuning now to still other additional embodiments described herein, such embodiments are generally directed to an automotive foam-based seal that may include any multilayer composite as described herein.

According to certain embodiments, the automotive foam-based seal described herein may be formed according to any acceptable forming process for an automotive foam-based seal. According to certain embodiments, the automotive foam-based seal may be formed by providing a foam layer and coating additional topcoat layers directly onto a surface of the foam layer. According to particular embodiments, the topcoat layers may be formed by providing a topcoat layer aqueous forming solution, coating the topcoat layer aqueous forming solution onto the foam layer, and then curing (i.e., thermally curing) the topcoat layer aqueous forming solution to form the topcoat layer. According to still other embodiments, multiple topcoat layers may be formed by providing a first topcoat layer aqueous forming solution, coating the first topcoat layer aqueous forming solution onto the foam layer, curing (i.e., thermally curing) the first topcoat layer aqueous forming solution to form the topcoat layer, then providing a second topcoat layer aqueous forming solution, coating the second topcoat layer aqueous forming solution onto the first topcoat layer, and curing (i.e., thermally curing) the second topcoat layer aqueous forming solution to form the second topcoat layer. It will be appreciated that the above noted process may be used to form any desired number of topcoat layers on the foam layer.

According to another embodiment, the automotive foam-based seal may be formed using a lamination process where the porous foam and additional layers are laminated using a transfer adhesive such as, for example, a silicon adhesive, a rubber adhesive, an acrylic adhesive, a phenolic adhesive, a polyurethane-based adhesive, or any combination thereof. According to still other embodiments, the automotive foam-based seal may be formed using a lamination process with a porous foam and additional layers, where the coating on the additional layers is an adhesive, such as, a silicon adhesive, a rubber adhesive, an acrylic adhesive, a phenolic adhesive, a polyurethane-based adhesive, or any combination thereof. According to still other embodiments, the automotive foam-based seal may be formed using a direct cast forming process, wherein the foam is directly cast onto the additional films or between the additional films.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer composite material comprising: a foam layer, and a multilayer topcoat component overlying the foam layer, wherein the multilayer topcoat component comprises: a first topcoat layer comprising a polyether polyurethane material, and a second topcoat layer comprising a hydrophobic polyurethane material, wherein the second topcoat layer overlies the first topcoat layer, and wherein the multilayer composite material comprises a water resistance rating of at least about 10 hours.

Embodiment 2. The multilayer composite material of embodiment 1, wherein the first topcoat layer comprises a polyether polyurethane material content of at least about 90 wt. % for a total weight of the first topcoat layer.

Embodiment 3. The multilayer composite material of embodiment 1, wherein the first topcoat layer is formed from a first topcoat layer aqueous forming solution comprising a polyether polyurethane material solid content of at least about 15 wt. % for a total weight of the first topcoat layer aqueous forming solution.

Embodiment 4. The multilayer composite material of embodiment 1, wherein the first topcoat layer is formed from a first topcoat layer aqueous forming solution comprising a polyether polyurethane material solid content of not greater than about 50 wt. % for a total weight of the first topcoat layer aqueous forming solution.

Embodiment 5. The multilayer composite material of embodiment 1, wherein the second topcoat layer comprises a hydrophobic polyurethane material content of at least about 90 wt. % for a total weight of the second topcoat layer.

Embodiment 6. The multilayer composite material of embodiment 1, wherein the second topcoat layer is formed from a second topcoat layer aqueous forming solution comprising a hydrophobic polyurethane material solid content of at least about 15 wt. % for a total weight of the second topcoat layer aqueous forming solution.

Embodiment 7. The multilayer composite material of embodiment 1, wherein the second topcoat layer is formed from a second topcoat layer aqueous forming solution comprising a hydrophobic polyurethane material solid content of not greater than about 50 wt. % for a total weight of the second topcoat layer aqueous forming solution.

Embodiment 8. The multilayer composite material of embodiment 1, wherein the first topcoat layer aqueous forming solution comprises a viscosity of at least about 200 mPa*s.

Embodiment 9. The multilayer composite material of embodiment 1, wherein the first topcoat layer aqueous forming solution comprises a viscosity of not greater than about 1000 mPa*s.

Embodiment 10. The multilayer composite material of embodiment 1, wherein the second topcoat layer aqueous forming solution comprises a viscosity of at least about 20 mPa*s.

Embodiment 11. The multilayer composite material of embodiment 1, wherein the second topcoat layer aqueous forming solution comprises a viscosity of not greater than about 400 mPa*s.

Embodiment 12. The multilayer composite material of embodiment 1, wherein the first topcoat layer aqueous forming solution comprises a pH value of at least about 7.0.

Embodiment 13. The multilayer composite material of embodiment 1, wherein the first topcoat layer aqueous forming solution comprises a pH value of not greater than about 10.0.

Embodiment 14. The multilayer composite material of embodiment 1, wherein the second topcoat layer aqueous forming solution comprises a pH value of at least about 3.0.

Embodiment 15. The multilayer composite material of embodiment 1, wherein the second topcoat layer aqueous forming solution comprises a pH value of not greater than about 6.0.

Embodiment 16. The multilayer composite material of embodiment 1, wherein the first topcoat layer aqueous forming solution comprises a specific gravity of at least about 950 kg/m³.

Embodiment 17. The multilayer composite material of embodiment 1, wherein the first topcoat layer aqueous forming solution comprises a specific gravity of not greater than about 1050 kg/m³.

Embodiment 18. The multilayer composite material of embodiment 1, wherein the second topcoat layer aqueous forming solution comprises a specific gravity of at least about 950 kg/m³.

Embodiment 19. The multilayer composite material of embodiment 1, wherein the second topcoat layer aqueous forming solution comprises a specific gravity of not greater than about 1050 kg/m³.

Embodiment 20. The multilayer composite material of embodiment 1, wherein the multilayer composite comprises a tackiness of at least about 0.1 kPa.

Embodiment 21. The multilayer composite material of embodiment 1, wherein the multilayer composite comprises a tackiness of not greater than about 18 kPa.

Embodiment 22. The multilayer composite material of embodiment 1, wherein the multilayer composite comprises a water resistance of at least about 10 hours.

Embodiment 23. The multilayer composite material of embodiment 1, wherein the multilayer topcoat component comprises a tackiness of at least about 0.1 kPa.

Embodiment 24. The multilayer composite material of embodiment 1, wherein the multilayer topcoat component comprises a tackiness of not greater than about 18 kPa.

Embodiment 25. The multilayer composite material of embodiment 1, wherein the multilayer topcoat component comprises a water resistance of at least about 10 hours.

Embodiment 26. The multilayer composite material of embodiment 1, wherein the first topcoat layer comprises a tackiness of at least about 0.1 kPa.

Embodiment 27. The multilayer composite material of embodiment 1, wherein the first topcoat layer comprises a tackiness of not greater than about 18 kPa.

Embodiment 28. The multilayer composite material of embodiment 1, wherein the first topcoat layer comprises a water resistance of at least about 1 hour.

Embodiment 29. The multilayer composite material of embodiment 1, wherein the second topcoat layer comprises a tackiness of at least about 23 kPa.

Embodiment 30. The multilayer composite material of embodiment 1, wherein the second topcoat layer comprises a tackiness of not greater than about 100 kPa.

Embodiment 31. The multilayer composite material of embodiment 1, wherein the second topcoat layer comprises a water resistance of at least about 10 hours.

Embodiment 32. The multilayer composite material of embodiment 1, wherein the multilayer composite comprises a thickness of at least about 1 mm.

Embodiment 33. The multilayer composite material of embodiment 1, wherein the multilayer composite comprises a thickness of not greater than about 20 mm.

Embodiment 34. The multilayer composite material of embodiment 1, wherein the foam layer comprises a thickness of at least about 1 mm.

Embodiment 35. The multilayer composite material of embodiment 1, wherein the foam layer comprises a thickness of not greater than about 20 mm.

Embodiment 36. The multilayer composite material of embodiment 1, wherein the multilayer topcoat component comprises a thickness of at least about 5 microns.

Embodiment 37. The multilayer composite material of embodiment 1, wherein the multilayer topcoat component comprises a thickness of not greater than about 40 microns.

Embodiment 38. The multilayer composite material of embodiment 1, wherein the first topcoat layer comprises a thickness of at least about 2 microns.

Embodiment 39. The multilayer composite material of embodiment 1, wherein the first topcoat layer comprises a thickness of not greater than about 20 microns.

Embodiment 40. The multilayer composite material of embodiment 1, wherein the second topcoat layer comprises a thickness of at least about 2 microns.

Embodiment 41. The multilayer composite material of embodiment 1, wherein the second topcoat layer comprises a thickness of not greater than about 20 microns.

Embodiment 42. An automotive foam-based seal comprising: a foam layer, and a multilayer topcoat component overlying the foam layer, wherein the multilayer topcoat component comprises: a first topcoat layer comprising a polyether polyurethane material, and a second topcoat layer comprising a hydrophobic polyurethane material, wherein the second topcoat layer overlies the first topcoat layer, and wherein the automotive foam-based seal comprises a water resistance rating of at least about 10 hours.

Embodiment 43. The automotive foam-based seal of embodiment 42, wherein the first topcoat layer comprises a polyether polyurethane material content of at least about 90 wt. % for a total weight of the first topcoat layer.

Embodiment 44. The automotive foam-based seal of embodiment 42, wherein the first topcoat layer is formed from a first topcoat layer aqueous forming solution comprising a polyether polyurethane material solid content of at least about 15 wt. % for a total weight of the first topcoat layer aqueous forming solution.

Embodiment 45. The automotive foam-based seal of embodiment 42, wherein the first topcoat layer is formed from a first topcoat layer aqueous forming solution comprising a polyether polyurethane material solid content of not greater than about 50 wt. % for a total weight of the first topcoat layer aqueous forming solution.

Embodiment 46. The automotive foam-based seal of embodiment 42, wherein the second topcoat layer comprises a hydrophobic polyurethane material content of at least about 90 wt. % for a total weight of the second topcoat layer.

Embodiment 47. The automotive foam-based seal of embodiment 42, wherein the second topcoat layer is formed from a second topcoat layer aqueous forming solution comprising a hydrophobic polyurethane material solid content of at least about 15 wt. % for a total weight of the second topcoat layer aqueous forming solution.

Embodiment 48. The automotive foam-based seal of embodiment 42, wherein the second topcoat layer is formed from a second topcoat layer aqueous forming solution comprising a hydrophobic polyurethane material solid content of not greater than about 50 wt. % for a total weight of the second topcoat layer aqueous forming solution.

Embodiment 49. The automotive foam-based seal of embodiment 42, wherein the first topcoat layer aqueous forming solution comprises a viscosity of at least about 200 mPa*s.

Embodiment 50. The automotive foam-based seal of embodiment 42, wherein the first topcoat layer aqueous forming solution comprises a viscosity of not greater than about 1000 mPa*s.

Embodiment 51. The automotive foam-based seal of embodiment 42, wherein the second topcoat layer aqueous forming solution comprises a viscosity of at least about 20 mPa*s.

Embodiment 52. The automotive foam-based seal of embodiment 42, wherein the second topcoat layer aqueous forming solution comprises a viscosity of not greater than about 400 mPa*s.

Embodiment 53. The automotive foam-based seal of embodiment 42, wherein the first topcoat layer aqueous forming solution comprises a pH value of at least about 7.0.

Embodiment 54. The automotive foam-based seal of embodiment 42, wherein the first topcoat layer aqueous forming solution comprises a pH value of not greater than about 10.0.

Embodiment 55. The automotive foam-based seal of embodiment 42, wherein the second topcoat layer aqueous forming solution comprises a pH value of at least about 3.0.

Embodiment 56. The automotive foam-based seal of embodiment 42, wherein the second topcoat layer aqueous forming solution comprises a pH value of not greater than about 6.0.

Embodiment 57. The automotive foam-based seal of embodiment 42, wherein the first topcoat layer aqueous forming solution comprises a specific gravity of at least about 950 kg/m³.

Embodiment 58. The automotive foam-based seal of embodiment 42, wherein the first topcoat layer aqueous forming solution comprises a specific gravity of not greater than about 1050 kg/m³.

Embodiment 59. The automotive foam-based seal of embodiment 42, wherein the second topcoat layer aqueous forming solution comprises a specific gravity of at least about 950 kg/m³.

Embodiment 60. The automotive foam-based seal of embodiment 42, wherein the second topcoat layer aqueous forming solution comprises a specific gravity of not greater than about 1050 kg/m³.

Embodiment 61. The automotive foam-based seal of embodiment 42, wherein the multilayer composite comprises a tackiness of at least about 0.1 kPa.

Embodiment 62. The automotive foam-based seal of embodiment 42, wherein the multilayer composite comprises a tackiness of not greater than about 18 kPa.

Embodiment 63. The automotive foam-based seal of embodiment 42, wherein the multilayer composite comprises a water resistance of at least about 10 hours.

Embodiment 64. The automotive foam-based seal of embodiment 42, wherein the multilayer topcoat component comprises a tackiness of at least about 0.1 kPa.

Embodiment 65. The automotive foam-based seal of embodiment 42, wherein the multilayer topcoat component comprises a tackiness of not greater than about 18 kPa.

Embodiment 66. The automotive foam-based seal of embodiment 42, wherein the multilayer topcoat component comprises a water resistance of at least about 10 hours.

Embodiment 67. The automotive foam-based seal of embodiment 42, wherein the first topcoat layer comprises a tackiness of at least about 0.1 kPa.

Embodiment 68. The automotive foam-based seal of embodiment 42, wherein the first topcoat layer comprises a tackiness of not greater than about 18 kPa.

Embodiment 69. The automotive foam-based seal of embodiment 42, wherein the first topcoat layer comprises a water resistance of at least about 1 hour.

Embodiment 70. The automotive foam-based seal of embodiment 42, wherein the second topcoat layer comprises a tackiness of at least about 23 kPa.

Embodiment 71. The automotive foam-based seal of embodiment 42, wherein the second topcoat layer comprises a tackiness of not greater than about 100 kPa.

Embodiment 72. The automotive foam-based seal of embodiment 42, wherein the second topcoat layer comprises a water resistance of at least about 10 hours.

Embodiment 73. The automotive foam-based seal of embodiment 42, wherein the multilayer composite comprises a thickness of at least about 1 mm.

Embodiment 74. The automotive foam-based seal of embodiment 42, wherein the multilayer composite comprises a thickness of not greater than about 20 mm.

Embodiment 75. The automotive foam-based seal of embodiment 42, wherein the foam layer comprises a thickness of at least about 1 mm.

Embodiment 76. The automotive foam-based seal of embodiment 42, wherein the foam layer comprises a thickness of not greater than about 20 mm.

Embodiment 77. The automotive foam-based seal of embodiment 42, wherein the multilayer topcoat component comprises a thickness of at least about 5 microns.

Embodiment 78. The automotive foam-based seal of embodiment 42, wherein the multilayer topcoat component comprises a thickness of not greater than about 40 microns.

Embodiment 79. The automotive foam-based seal of embodiment 42, wherein the first topcoat layer comprises a thickness of at least about 2 microns.

Embodiment 80. The automotive foam-based seal of embodiment 42, wherein the first topcoat layer comprises a thickness of not greater than about 20 microns.

Embodiment 81. The automotive foam-based seal of embodiment 42, wherein the second topcoat layer comprises a thickness of at least about 2 microns.

Embodiment 82. The automotive foam-based seal of embodiment 42, wherein the second topcoat layer comprises a thickness of not greater than about 20 microns.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer composite material comprising:
a foam layer, and
a multilayer topcoat component overlying the foam layer,
wherein the multilayer topcoat component comprises:
a first topcoat layer comprising a polyether polyurethane material, and
a second topcoat layer comprising a hydrophobic polyurethane material,
wherein the second topcoat layer overlies the first topcoat layer, and
wherein the multilayer composite material comprises a water resistance rating of at least about 10 hours.

2. The multilayer composite material of claim 1, wherein the first topcoat layer comprises a polyether polyurethane material content of at least about 90 wt. % for a total weight of the first topcoat layer.

3. The multilayer composite material of claim 1, wherein the first topcoat layer is formed from a first topcoat layer aqueous forming solution comprising a polyether polyurethane material solid content of at least about 15 wt. % for a total weight of the first topcoat layer aqueous forming solution.

4. The multilayer composite material of claim 1, wherein the first topcoat layer is formed from a first topcoat layer aqueous forming solution comprising a polyether polyurethane material solid content of not greater than about 50 wt. % for a total weight of the first topcoat layer aqueous forming solution.

5. The multilayer composite material of claim 1, wherein the second topcoat layer comprises a hydrophobic polyurethane material content of at least about 90 wt. % for a total weight of the second topcoat layer.

6. The multilayer composite material of claim 1, wherein the second topcoat layer is formed from a second topcoat layer aqueous forming solution comprising a hydrophobic polyurethane material solid content of at least about 15 wt. % for a total weight of the second topcoat layer aqueous forming solution.

7. The multilayer composite material of claim 1, wherein the second topcoat layer is formed from a second topcoat layer aqueous forming solution comprising a hydrophobic polyurethane material solid content of not greater than about 50 wt. % for a total weight of the second topcoat layer aqueous forming solution.

8. The multilayer composite material of claim 1, wherein the first topcoat layer aqueous forming solution comprises a viscosity of at least about 200 mPa*s and not greater than about 1000 mPa*s.

9. The multilayer composite material of claim 1, wherein the second topcoat layer aqueous forming solution comprises a viscosity of at least about 20 mPa*s and not greater than about 400 mPa*s.

10. The multilayer composite material of claim 1, wherein the first topcoat layer aqueous forming solution comprises a pH value of at least about 7.0 and not greater than about 10.0.

11. The multilayer composite material of claim 1, wherein the second topcoat layer aqueous forming solution comprises a pH value of at least about 3.0 and not greater than about 6.0.

12. The multilayer composite material of claim 1, wherein the multilayer composite comprises a tackiness of at least about 0.1 kPa.

13. The multilayer composite material of claim 1, wherein the multilayer composite comprises a tackiness of not greater than about 18 kPa.

14. The multilayer composite material of claim 1, wherein the multilayer composite comprises a water resistance of at least about 72 hours.

15. An automotive foam-based seal comprising:
a foam layer, and
a multilayer topcoat component overlying the foam layer,
wherein the multilayer topcoat component comprises:
a first topcoat layer comprising a polyether polyurethane material, and
a second topcoat layer comprising a hydrophobic polyurethane material,
wherein the second topcoat layer overlies the first topcoat layer, and
wherein the automotive foam-based seal comprises a water resistance rating of at least about 10 hours.

16. The automotive foam-based seal of claim 15, wherein the first topcoat layer comprises a polyether polyurethane material content of at least about 90 wt. % for a total weight of the first topcoat layer.

17. The automotive foam-based seal of claim 15, wherein the first topcoat layer is formed from a first topcoat layer aqueous forming solution comprising a polyether polyurethane material solid content of at least about 15 wt. % for a total weight of the first topcoat layer aqueous forming solution.

18. The automotive foam-based seal of claim 15, wherein the first topcoat layer is formed from a first topcoat layer aqueous forming solution comprising a polyether polyurethane material solid content of not greater than about 50 wt. % for a total weight of the first topcoat layer aqueous forming solution.

19. The automotive foam-based seal of claim 15, wherein the second topcoat layer comprises a hydrophobic polyurethane material content of at least about 90 wt. % for a total weight of the second topcoat layer.

20. The automotive foam-based seal of claim 15, wherein the second topcoat layer is formed from a second topcoat layer aqueous forming solution comprising a hydrophobic polyurethane material solid content of at least about 15 wt. % for a total weight of the second topcoat layer aqueous forming solution.
